(19) United States
(12) Patent Application Publication
(10) Pub. No.: US 2011/0121185 A1
(43) Pub. Date: May 26, 2011

(54) RADIATION IMAGE DETECTING APPARATUS

(76) Inventors: Yoko Hirai, Tokyo (JP); Takehiko Shoji, Tokyo (JP); Takafumi Yanagita, Tokyo (JP)

(21) Appl. No.: 13/055,001

(22) PCT Filed: Feb. 26, 2009
(86) PCT No.: PCT/JP2009/053539

§ 371 Date: Jan. 20, 2011

(51) Int. Cl. G01T 1/20

(52) U.S. Cl. 250/361 R

(57) ABSTRACT

There is disclosed a radiation image detecting apparatus which has achieved enhanced moisture resistance of a scintillator and enhanced image quality such as sharpness of a radiation image. The radiation image detecting apparatus is provided with a scintillator panel comprising a phosphor layer on a substrate and a photoelectric conversion panel, in which the scintillator panel is held between the photoelectric conversion panel and an opposed base material, and the periphery of the photoelectric conversion panel adheres to the periphery of the opposed base material with an adhesive, and pressure of a gas in the space between the photoelectric conversion panel and the opposed base material being lower than an atmospheric pressure.

### TECHNICAL FIELD

The present invention relates to a radiation image detecting apparatus used in formation of a radiation image of a subject.

### TECHNICAL BACKGROUND

There have been broadly employed radiographic images such as X-ray images for diagnosis of the conditions of patients on the wards. Specifically, radiographic images using an intensifying-screen/film system have achieved enhancement of speed and image quality over its long history and are still used on the scene of medical treatment as an imaging system having high reliability and superior cost performance in combination. However, these image data are so-called analog image data, in which free image processing or instantaneous image transfer cannot be realized.

Recently, there appeared digital system radiographic image detection apparatuses, as typified by a computed radiography (also denoted simply as CR) and a radiation flat panel detector (also denoted simply as FPD). In these apparatuses, digital radiographic images are obtained directly and can be displayed on an image display apparatus such as a cathode ray tube or liquid crystal panels, which renders it unnecessary to form images on photographic film. Accordingly, digital system radiographic image detection apparatuses have resulted in reduced necessities of image formation by a silver salt photographic system and leading to drastic improvement in convenience for diagnosis in hospitals or medical clinics.

The computed radiography (CR) as one of the digital technologies for radiographic imaging has been accepted mainly at medical sites. However, image sharpness is insufficient and spatial resolution is also insufficient, which have not yet reached the image quality level of the conventional screen/film system. Further, there appeared, as a digital X-ray imaging technology, an X-ray fiat panel detector (FPD) using a thin film transistor (TFT) for photoelectric conversion, as described in, for example, the article “Amorphous Semiconductor Usher in Digital X-ray Imaging” described in Physics Today, November, 1997, page 24 and also in the article “Development of a High Resolution, Active Matrix, Flat-Panel Imager with Enhanced Fill Factor” described in SPIE, vol. 32, page 2 (1997).

To achieve high quality images by a FPD, it is important to allow a scintillator and a photoelectric conversion panel to be in contact with each other, for which there have been disclosed various kinds of techniques. Of those techniques, a technique of allowing a scintillator to be adhered under reduced pressure, as disclosed in Patent document 1, made it feasible to be bound to the scintillator, which was advantageous in terms of pressure to various members. In this technique, however, adhesive is present between a scintillator and a photoelectric conversion panel, which made it difficult to achieve sufficient contact between them.

Patent document 1: JP 2007-285709A

### DISCLOSURE OF THE INVENTION

### Problem to be Solved

The present invention has come into being in view of the foregoing problems and circumstances. It is an object of the present invention to provide a radiation image detecting apparatus which has achieved improvements in adhesion between a scintillator panel and a photoelectric conversion panel and enhancements in moisture resistance of a scintillator and sharpness of radiation images.

### Means for Solving the Problem

The foregoing problems related to the invention can be overcome by the means described below.

1. A radiation image detecting apparatus provided with a photoelectric conversion panel and a scintillator panel comprising a phosphor layer on a substrate, wherein the scintillator panel is held between the photoelectric conversion panel and an opposed base material, and a periphery of the photoelectric conversion panel and a periphery of the opposed base material adhere together with an adhesive, and the pressure of a gas in the space between the photoelectric conversion panel and the opposed base material being lower than an atmospheric pressure.

2. The radiation image detecting apparatus described in the foregoing 1, wherein the scintillator panel and the opposed base material adhere together, and the scintillator panel is in contact with the photoelectric panel under reduced pressure.

3. The radiation image detecting apparatus described in the foregoing 1 or 2, wherein a moisture permeability at adhered portions on the peripheries is not more than 30 g/m²/μm under a temperature of 40° C. and a relative humidity of 90%.

4. The radiation image detecting apparatus described in any of the foregoing 1 to 3, wherein the substrate of the scintillator panel exhibits flexibility.

5. The radiation image detecting apparatus described in any of the foregoing 1 to 4, wherein the phosphor layer is directly in contact with the photoelectric conversion panel.

6. The radiation image detecting apparatus described in any of the foregoing 1 to 5, wherein the phosphor layer is formed by deposition through a gas phase process.

7. The radiation image detecting apparatus described in any of the foregoing 1 to 6, wherein the phosphor layer is formed from raw materials of cesium iodide and an additive containing thallium.

### EFFECT OF THE INVENTION

According to the foregoing means, there can be provided a radiation image detecting apparatus improved in adhesion between the scintillator panel and the photoelectric conversion panel and enhanced in moisture resistance of the scintillator and sharpness of radiation images.

### BRIEF DESCRIPTION OF THE DRAWINGS

FIGS. 1(a), 1(b) and 1(c) illustrate examples of scintillator panels of (a) a scintillator panel 12 not having a protective layer and being in direct contact with a photoelectric conversion panel; (b) a scintillator panel being covered with a protective layer comprised of a resin film; and (c) a scintillator panel being covered with a polyp-xylylene) film (also called parylene

FIGS. 2(a) and 2(b) show a perspective view (a) and a sectional view (b) of a part of constitution of a radiation image detecting apparatus of the invention.

FIG. 3 shows a schematic view of a vapor deposition device.

FIGS. 4(a) and 4(b) show a schematic view of a photoelectric conversion panel in a radiation image detecting apparatus.

FIG. 5 shows a perspective sectional view with being partially sectioned, of a radiation image detecting apparatus.

FIG. 6 shows an enlarged sectional view of an imaging panel (51).

### DESCRIPTION OF NUMERIC DESIGNATIONS

10, 12: Scintillator panel,

13: Light-receiving element (photoelectric panel)

14: Housing

15: Protective cover

21: Foamed material layer

31: Opposed base material

32: Adhesive

41: Sealed reduced-pressure space

121: Substrate

122: Phosphor layer

123: Protective layer

124: Poly-p-xylylene film

961: Vapor deposition device

962: Vacuum vessel

963: Boat (to be filled with material)

964: Holder

965: Rotation mechanism

966: Vacuum pump

1a: Photoelectric conversion element section

2a: Adhesive

3a: Base board

4a: Photoelectric conversion panel

5a: Scintillator

6a: Bump

7a: Base board

8a: Hole

9a: Sealing material

100: Radiation image detecting device

### PREFERRED EMBODIMENTS OF THE INVENTION

The radiation image detecting apparatus of the present invention is featured in that the apparatus is provided with a scintillator panel comprising a phosphor layer on the substrate and a photoelectric conversion panel, in which the scintillator panel is held between the photoelectric conversion panel and an opposed base material, the periphery of the photoelectric conversion panel adheres to the periphery of the opposed base material with an adhesive, and the pressure of a gas in a space between the photoelectric conversion panel and the opposed base material is lower than atmospheric pressure. This feature is a technical feature in common with the invention related to the foregoing 1 to 6.

In the embodiments of the invention, it is preferred that the scintillator panel adheres to the opposed base material and the scintillator panel is brought into contact with the photoelectric panel through reduced pressure. Herein, the pressure of a gas in the space between the photoelectric panel and the opposed base material is preferably from 100 to 9000 Pa, and more preferably from 100 to 6000 Pa. Further, it is preferred in terms of being superior in handling property that the scintillator panel is secured while being inserted between the photoelectric conversion panel and the opposed base material.

It is also preferred that the moisture permeability of the adhered portions of the foregoing peripheries is not more than 30 g/m²/μm under a temperature of 40° C. and a relative humidity of 90%. Furthermore, the substrate of the scintillator panel preferably is flexible.

Preferably, the phosphor layer related to the invention is directly in contact with the photoelectric conversion panel. The phosphor layer is formed preferably by a process of gas phase deposition; it is also preferably formed of cesium iodide and an thallium-containing additive.

Hereinafter, there will be detailed the present invention, and constituent elements and preferred embodiments of the invention.

### Constitution and Feature of Radiation Image Detecting Apparatus of the Invention:

The foregoing features of the radiation image detecting apparatus of the present invention will be further described with reference to the drawings.

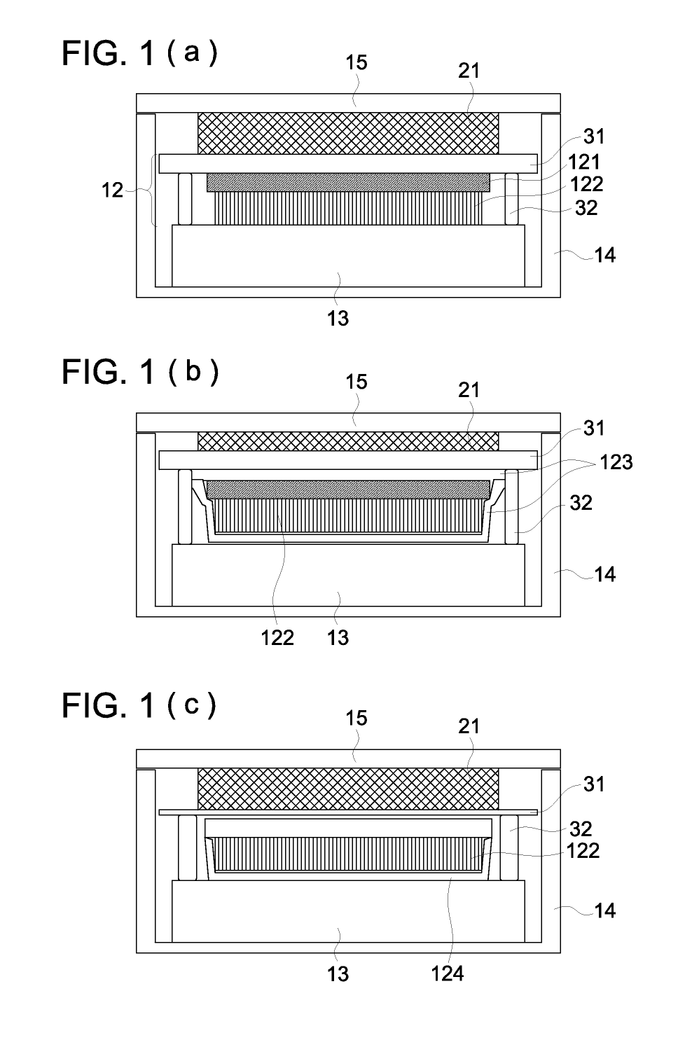

FIGS. 1(a), 1(b) and 1(c) illustrate schematic view showing examples of a method in which a scintillator panel and a photoelectric conversion panel are sealed and allowed to be in contact with each other by reduced pressure, wherein a radiation-transmissive opposed base material 31 is disposed on the side of a substrate 121 of a scintillator panel 12 to form a sealed space in the scintillator panel and the photoelectric conversion panel. In this constitution, the scintillator panel and the photoelectric conversion panel are in contact with each other by reducing the pressure of a sealed space 41. The contact pressure of the scintillator panel 12 to the photoelectric conversion panel 13 is controlled by the pressure reduction degree of the sealed space 41.

FIG. 1(a) illustrates an example of a scintillator panel having no protective layer being in contact with a photoelectric conversion panel. A cushioning material is provided on the side of an opposed material opposite the scintillator panel to prevent damage or dislocation of the scintillator panel. Examples of such a cushioning material include silicone, urethane polyethylene and polypropylene foams.

FIG. 1(b) illustrates an example of the scintillator panel 12 being covered with a protective layer 123 formed of a resin film in the foregoing example of FIG. 1(a).

FIG. 1(c) illustrates an example of the scintillator panel 12 being covered with a poly(p-xylylene) film (also called parylene film), as a protective layer.

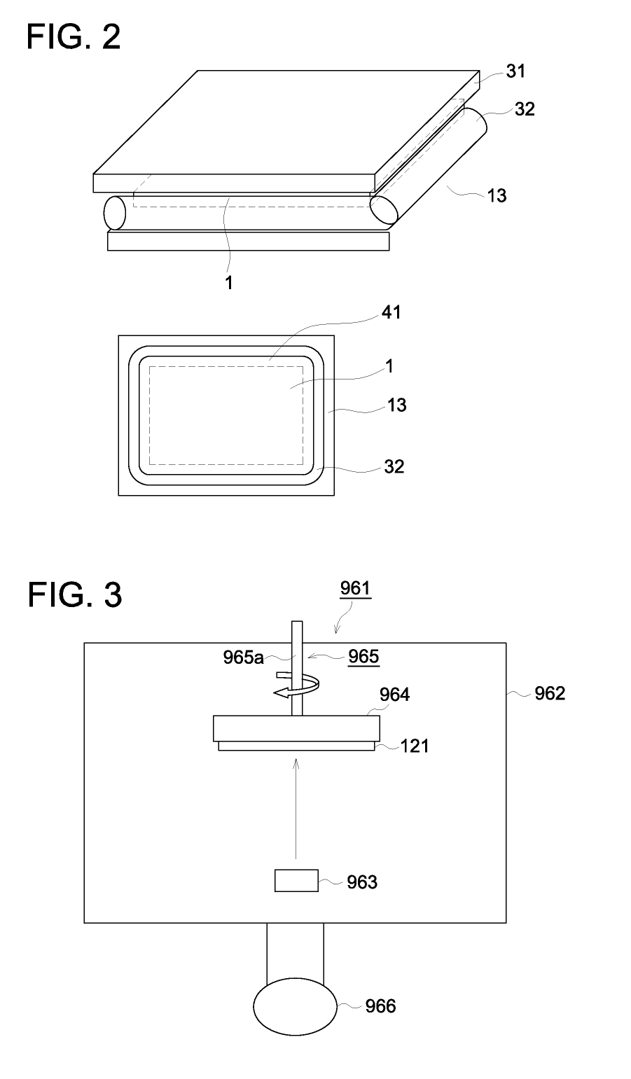

FIGS. 2(a) and 2(b) show a perspective view (a) and a sectional view (b) of a part of constitution of a radiation image detecting apparatus of the invention.

### Constitution of Scintillator Panel:

The scintillator panel related to the invention preferably is a scintillator panel provided with a phosphor layer comprised of columnar crystals on a polymeric film substrate, and more preferably, a sublayer is provided between the substrate and the phosphor layer. Alternatively, there may be provided a reflection layer on the substrate and the scintillator panel may comprise a reflection layer, a sublayer and a phosphor layer.

Hereinafter, there will be described the individual constituting layers and constituting elements.

### Phosphor Layer (Scintillator Layer):

A material to form a scintillator layer related to the invention may employ a variety of commonly known phosphor materials, of which cesium iodide (CsI) is employed as a main component in the invention, since it exhibits an enhanced conversion rate of X-rays to visible light and readily forms a columnar crystal structure of a phosphor, whereby scattering of emitted light within the crystal is inhibited through the light guiding effect, rendering it feasible to increase the scintillator layer thickness.

CsI exhibits by itself a relatively low emission efficiency so that various activators are incorporated. For example, JP-B No. 54-35060 disclosed a mixture of CsI and sodium iodide (NaI) at any mixing ratio. Further, JP-A No. 2001-59899 disclosed vapor deposition of CsI containing an activator, such as thallium (Tl), europium (Eu), indium (In), lithium (Li), potassium (K), rubidium (Ru) or sodium (Na). In the present invention, thallium (Tl) or europium (Eu) is preferred, of which thallium (Tl) is more preferred.

In the present invention, it is preferred to employ, as raw materials, cesium iodide and an additive containing at least one thallium compound. Namely, thallium-activated cesium iodide (denoted as CsI:Tl), which exhibits a broad emission within the wavelength region of from 400 to 750 nm, is preferred.

There can be employed various thallium compounds (that is, a compound having an oxidation number of +I or +III) as a thallium compound contained in such an additive.

Preferred examples of thallium compounds include thallium bromide (TlBr), thallium chloride (TlCl), and thallium fluoride (TlF).

The melting point of a thallium compound relating to the present invention is preferably in the range of 400 to 700° C. A melting point higher than 700° C. results in inhomogeneous inclusions of an additive within the columnar crystal. In the present invention, the melting point is one under ordinary temperature and ordinary pressure.

In the scintillator layer of the present invention, the content of an additive, as described above is desirably optimized in accordance with its object or performance but is preferably from 0.001 to 50.0 mol % of cesium iodide, and more preferably from 0.1 to 10.0 mol %.

An additive content of less than 0.001 mol % of cesium iodide results in an emission luminance which is at an almost identical level to the emission luminance obtained by cesium iodide alone. An additive content of more than 50 mol % makes it difficult to maintain the properties or functions of cesium iodide.

The thickness of the phosphor layer (or scintillator layer) is preferably 100 to 800 μm and more preferably 120 to 700 μm to achieve balanced characteristics of luminance and sharpness.

### Substrate (Support):

The scintillator panel of the invention may use, as a substrate (also called support), aluminum, a metal substrate mainly composed of aluminum, a substrate of other metals, a quartz glass, a plastic resin, CFRP, aramid laminated board, or the like, and a polymer film is preferably used. There are usable polymer films (plastic films) such as cellulose acetate film, polyester film, polyethylene terephthalate (PET) film, polyethylene naphthalate (PEN) film, polyamide film, polyimide (PI) film, triacetate film, polycarbonate film and carbon fiber reinforced resin. A polymer film containing a polyimide or polyethylene naphthalate is specifically suitable when forming phosphor columnar crystals with a raw material of cesium iodide by a process of gas phase deposition.

The substrate related to the invention preferably is a 50-500 μm thick, flexible polymer film.

Herein, the flexible substrate refers to a substrate exhibiting an elastic modulus at 120 ° C. (also denoted as E120) of 1000 to 6000 N/mm². Such a substrate preferably is a polymer film containing polyimide or polyethylene naphthalate.

In the region showing a linear relationship between strain and corresponding stress which is measured by using a tensile strength tester based on JIS C 2318, the elastic modulus is calculated as the slope of the straight portion of the stress-strain curve, that is, a strain divided by a stress. It is also referred to as a Young's modulus. In the invention, such a Young's modulus is also defined as the elastic modulus.

The substrate used in the invention preferably exhibits an elastic modulus at 120° C. (E120) of 1000 to 6000 N/mm², and more preferably 1200 to 5000 N/mm².

Specific examples include polymer film comprised of polyethylene naphthalate (E120=4100 N/mm²), polyethylene terephthalate (E120=1500 N/mm²), polybutylene naphthalate (E120=1600 N/mm²), polycarbonate (E120=1700 N/mm²), syndiotactic polystyrene (E120=2200 N/mm²), polyether imide (E120=1900 N/mm²), polyacrylate (E120=1700 N/mm²), polysulfone (E120=1800 N/mm²) or polyether sulfone (E120=1700 N/mm²).

These may be used singly or in combination, or laminated. Of these polymer films, a polymer film comprising polyimide or polyethylene naphthalate is preferred.

Adhesion of the scintillator panel to the surface of a planar light receiving element is often affected by deformation or warpage of the support (substrate) during deposition, rendering it difficult to achieve a uniform image quality characteristic within the light receiving surface of a flat panel detector. In such a case, a 50-500 μm thick polymer film is used as the support (substrate), whereby the scintillator panel is deformed with being fitted to the form of the surface of a planar light receiving element, leading to uniform sharpness over all of the light-receiving surface of the flat panel detector.

### Reflection Layer:

In the invention, it is preferred to provide a reflection layer (also denoted as a metal reflection layer) on the support (substrate). Light emitted from a phosphor (scintillator) is reflected, resulting in enhanced light-extraction efficiency. The reflection layer is preferably formed of a material containing an element selected from the group consisting of Al, Ag, Cr, Cu, Ni, Ti, Mg, Rh, Pt, and Au. It is specifically preferred to employ a metal thin-film composed of the foregoing elements, for example, Ag film or Al film. Such a metal film may be formed of two or more layers. When a metal film is formed to two or more layers, the lower layer preferably is a layer containing Cr, whereby enhanced adhesion to the substrate is achieved. A layer comprised of a metal oxide such as SiO₂ or TiO₂ may be provided on the metal thin-film to achieve enhanced reflectance.

The thickness of a reflection layer is preferably 0.005 to 0.3 μm in terms of emission-extraction efficiency, and more preferably 0.01 to 0.2 μm.

### Sublayer:

In the invention, it is preferred in terms of adhesion to provide a sublayer between the substrate and the phosphor layer, or between a reflection layer and a phosphor layer. Such a sublayer preferably contains a polymeric binder (binder), a dispersing agent or the like. The thickness of a sublayer is preferably from 0.5 to 4 μm.

There will be further described constituents of a sublayer.

### Polymeric Binder:

The sublayer related to the invention is formed preferably by coating a polymeric binder material (hereinafter, also denoted simply as a binder) dissolved or dispersed in a solvent, followed by drying. Specific examples of such a polymeric binder include a polyurethane, vinyl chloride copolymer, poly[(vinyl chloride)-co-(vinyl acetate)], poly[(vinyl chloride)-co-(vinylidene chloride)], poly[(vinyl chloride)-co-acrylonitrile], poly(butadiene-co-acrylonitrile), polyvinyl acetal, polyester, cellulose derivatives (e.g., nitrocellulose), polyimide, polyamide, poly-p-xylylene, poly(styrene-co-butadiene), various synthetic rubber resins, phenol resin, epoxy resin, urea resin, melamine resin, phenoxy resin, silicone resin, acryl resin and urea formamide resin. Of these, it is preferred to employ a polyester, a vinyl chloride copolymer, polyvinyl butyral or nitrocellulose.

The polymeric binder related to the invention preferably is a polyester, a vinyl chloride copolymer, polyvinyl butyral or nitrocellulose, in terms of adhesion. A polyester resin is specifically preferred.

Examples of a solvent for use in preparation of a sublayer include a lower alcohol such as methanol, ethanol, n-propanol or n-butanol; a chlorine-containing hydrocarbon such as methylene chloride or ethylene chloride; a ketone such as acetone, methyl ethyl ketone or methyl isobutyl ketone; an aromatic compound such as toluene, benzene, cyclohexane, cyclohexanone or xylene; an ester of a lower carboxylic acid and a lower alcohol, such as methyl acetate, ethyl acetate or butyl acetate; an ether such as dioxane, ethylene glycol monoethyl ester, or ethylene glycol monomethyl ester, and an ether such as dioxane, ethylene glycol monoethyl ester, or ethylene glycol monomethyl ester.

The sublayer related to the invention may contain a pigment or a dye to inhibit scattering of light emitted from a phosphor (scintillator) to achieve enhanced sharpness.

### Protective Layer:

The scintillator panel related to the invention may be provided with a protective layer. A protective layer related to the invention mainly aims to protect a scintillator layer. Namely, cesium iodide (CsI) is a hygroscopic material, and absorbs moisture from the atmosphere to deliquesce so that it is a main aim to inhibit this.

The moisture-resistant protective layer can be formed by use of various materials. For instance, it is to form a p-xylylene membrane by a CVD process. Namely, it is to form a p-xylylene layer on all of the surfaces of a scintillator and a substrate, where a protective layer is formed.

Alternatively, a polymer film, as a protective layer, may be provided on the phosphor layer. A material of such a polymer film may employ a film similar to a polymer film as a support (substrate) material, as described later.

The thickness of a polymer film is preferably not less than 12 μm and not more than 120 μm, and more preferably not less than 20 μm and not more than 80 μm, taking into account formability of void portions, protectiveness of a phosphor layer, sharpness, moisture resistance and workability. Taking into account sharpness, uniformity of radiation image, production stability and workability, the haze factor is preferably not less than 3% and not more than 40%, and more preferably not less than 3% and not more than 10%. The haze factor is determined by using, for example, NDH 500W, made by Nippon Denshoku Kogyo Co., Ltd. Such a haze factor can be achieved by choosing commercially available polymer films.

Taking into account photoelectric conversion efficiency and scintillator emission wavelength, the light transmittance of the protective film is preferably not less than 70% at 550 nm; however, a film with light transmittance of 99% or more is not commercially available, so that it is substantially preferred to be from 70 to 99%.

Taking into account protectiveness and deliquescence of a scintillator layer, the moisture permeability of the protective film is preferably not more than 50 g/m²·day (40° C., 90% RH, measured in accordance with JIS Z 0208) and more preferably not more than 10 g/m²·day (40° C., 90% RH, measured in accordance with JIS Z 0208); however, a film of not more than 0.01 g/m²·day (40° C., 90% RH) is not commercially available, so that it is substantially preferred to be not less than 0.01 g/m²·day (40° C., 90% RH) and not more than 50 g/m²·day (40° C., 90% RH, measured in accordance with JIS Z 0208), and it is more preferred to be not less than 0.1 g/m²·day (40° C., 90% RH) and not more than 10 g/m²·day (40° C., 90% RH, measured in accordance with JIS Z 0208).

### Preparation Method of Scintillator Panel:

Hereinafter, a typical example of a preparation method of the scintillator panel related to the invention will be described with reference to a drawing.

### Vapor Deposition Device:

FIG. 3 shows a schematic constitution of a vapor deposition device. In the drawing, a vapor deposition device 961 is provided with a box-shaped vacuum vessel 962 and a boat 963 used for vacuum deposition is disposed in the interior of the vacuum vessel 962. The boat 963 is a member which is filled with an evaporation source, and is connected to an electrode. The boat 963 is heated by Joule heat upon applying electrical current to the boat 963 through the electrode. In the preparation of the scintillator panel 12 used for radiation, the boat 963 is filled with a mixture containing cesium iodide and an activator compound; the mixture is heated and evaporated by applying an electrical current to the boat 963.

The member in which an evaporation source is placed may use an alumina crucible around which a heater is wound or a refractory metal heater.

A holder 964 to hold a substrate 121 is disposed immediately above the boat 963 within the vacuum vessel 962. The holder 964 is provided with a heater (not shown in the drawing), whereby the substrate 1 placed on the holder 964 is heated by operating the heater. Heating the substrate by the heater eliminates or removes adsorbate on the surface of the substrate 121, inhibits generation of an impurity layer between the substrate 121 and the phosphor layer 122 formed thereon, achieves enhanced contact of the substrate 121 to the phosphor layer 122 formed thereon and controls the quality of the phosphor layer 122 formed on the substrate 121.

The holder 964 is provided with a rotation mechanism 965 to rotate the holder 964. The rotation mechanism 965 is constituted of a rotation shaft 965a connected to the holder 964 and a motor (not shown in the drawing), as a driving source. When driving the motor rotates the rotation shaft 965a, the holder 964 rotates, while opposing the boat 963.

In the vapor deposition device 961, the vacuum vessel is provided with a vacuum pump 966 in addition to the foregoing constitution. The vacuum pump 966 performs evacuation of the inside of the vacuum vessel 962 and introduction of a gas into the inside of the vacuum vessel 962. Operating the vacuum pump 966 can maintains the inside of the vacuum vessel 962 under a gas atmosphere at a prescribed pressure.

### Scintillator Panel:

Next, there will be described a preparation method of the scintillator panel 12 related to the invention. The vapor deposition device 961 described above can suitably be used for preparation of the scintillator panel 12 used for radiation. Hereinafter, there will be described a preparation method of the scintillator panel 12 by using the vapor deposition device 961.

### Formation of Reflection Layer:

A metal thin layer (such as Al film, Ag film or the like) as a reflection layer is formed on one side of the substrate 1 by a process of sputtering. There is also commercially available a film having an Al membrane on a polymer film and such a film can be used as the substrate of the invention. Formation of sublayer:

A sublayer is formed by coating the composition of a polymeric binder material dissolved or dispersed in an organic solvent, followed by drying. Such a polymeric binder material preferably is a hydrophobic resin such as a polyester resin, polyurethane resin or the like in terms of adhesiveness and corrosion resistance of a reflection layer.

### Formation of Phosphor Layer:

The substrate provided thereon with a reflection layer and a sublayer is placed onto the holder 964, and to plural boats (not shown in the drawing), a powdery mixture including cesium iodide and thallium iodide is charged (preliminary step). Herein, the distance between the boat 963 and the substrate 121 is set to be within a range of 100-1500 mm and the treatment of a vapor deposition step described below is performed, while maintaining the range of the set value. While maintaining the distance between the boat 963 and the substrate 121, which is more preferably not less than 400 mm and not more than 1500 mm, plural boats are simultaneously heated to perform evaporation.

After completing the preliminary step, the vacuum pump 966 is operated to evacuate the inside of the vacuum vessel 962 so that the inside of the vacuum vessel 962 is under a vacuum atmosphere of not more than 0.1 Pa (vacuum atmosphere forming step). Herein, the vacuum atmosphere refers to an atmosphere with a pressure of not more than 100 Pa, and a pressure atmosphere of not more than 0.1 Pa is suitable.

Then, inert gas such as argon or the like is introduced into the vacuum vessel 962 and the interior portion of the vacuum vessel 962 is maintained under a vacuum atmosphere of 0.001 to 5 Pa and more preferably 0.01 to 2 Pa. Thereafter, a heater of the holder 964 and the rotation mechanism 965 are driven, and the substrate 121 placed on the holder 964 and opposing the boat 963 is rotated, while being heated. The temperature of the substrate 121 on which a phosphor layer is to be formed is preferably set to room temperature (25° C.) to 50° C. at the time of the start of deposition, and 100 to 300° C., more preferably 150 to 250° C. during deposition.

In this state, an electrical current is applied to the boat 963 from the electrode to heat a mixture containing cesium iodide and thallium iodide to approximately 700° C. to evaporate the mixture, whereby numerous columnar crystals are successively grown on the surface of the substrate 121 to obtain crystals with a desired thickness (deposition step).

Although being described in the foregoing, various modifications and design changes in designation can be made without departing from the scope of the present invention.

As one of the modifications and design changes, a resistance heating method is performed in the foregoing deposition step but the treatment in this step may be a treatment performed by electron beams or by high-frequency induction. In the embodiments of the invention, it is preferred to apply a heating treatment by a resistance heating method in terms of being easily effected by a relatively simple constitution, low cost and applicability to many substances. When performing a heating treatment by a resistance heating method, there can be achieved both a heating treatment of a mixture of cesium iodide and thallium iodide and the vapor deposition treatment thereof.

As another modification and design change, there may be disposed a shutter (not shown in the drawing) between the boat 963 and the holder 964 of the deposition device 961 to interrupt the space portion from the boat 963 to the holder 964. In that case, substances other than the objective material and adhered to the surface of a mixture on the boat 963 are evaporated through the shutter, preventing the substances from adherence to the substrate 121 and inhibiting abnormal growth of columnar crystals, due to foreign material generated in the initial stage of deposition.

### Photoelectric Conversion Panel:

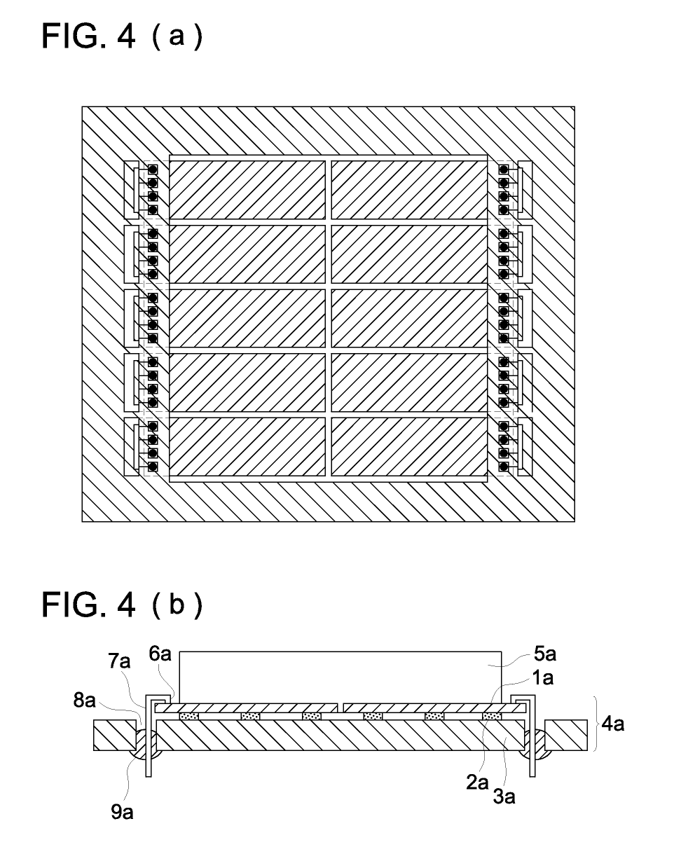

Hereinafter, the photoelectric conversion panel related to the invention will be described with reference to FIG. 4. FIGS. 4(a) and 4(b) show a schematic constitution of a photoelectric conversion panel in a radiation image detecting apparatus. FIG. 4(a) shows a top view of the apparatus and FIG. 4(b) shows a sectional view thereof. As shown in FIG. 4(b), a photoelectric conversion element section 1a to form photoelectric conversion elements is adhered onto a base board 3a by an adhesive 2a. This is referred to as photoelectric conversion panel 4a.

Photoelectric conversion elements formed in a photoelectric conversion element section 1a, which are typified by CCD, CMOS or a-Si photodiode (PIN type, MIS type), are arranged two-dimensionally in the photoelectric conversion element section 1a.

Plural sheets of photoelectric conversion element sections 1a (10 sheets in the drawing) are adhered and regularly arranged in a two-dimensional form.

The base board 3a may employ materials such as glass, ceramic, CFRP, aluminum and the like, and it is desirable that, taking into account heat applied in the process of production, there are chosen a scintillator panel 5a, the photoelectric conversion element section 1a and the base board 5a which are each close in thermal expansion coefficient.

### Opposed Base Material:

The opposed base material may use aluminum, a metal board mainly composed of aluminum, other metal boards, quartz glass, plastic rein, CFRP, and an aramid-laminated plate. There is preferably used an opposed base material which exhibits enhanced X-ray transmissivity and superior flatness and is close in thermal expansion factor to the photoelectric conversion panel.

### Adhesive:

In the radiation image detecting apparatus of the invention, the periphery of the photoelectric conversion panel and that of the opposed base material are adhered with an adhesive and preferably, it is controlled so that the moisture permeability in adhered portions of the foregoing peripheries is not more than 30 g/m per μm of adhesive coating thickness.

Adhesives usable in the invention may employ those known commonly in the art. Examples thereof include a two-component type, a thermo-hardenable type, a single-component type, an oxidation-hardenable type and the like. The composition may use raw materials such as acryl, urethane, epoxy, silicone, fluorine-containing resin and the like. An adhesive which results in a low moisture permeability after being hardened is desired in terms of the object of the invention. Further, in case of an adhesive dissolved in a solvent, the solvent is vaporized at the time of drying and may result in adverse effects on the apparatus, so that a solvent-free adhesive is preferable. Specifically, an epoxy type UV-hardenable or thermosetting adhesive is preferable.

### Radiation Image Detecting Apparatus:

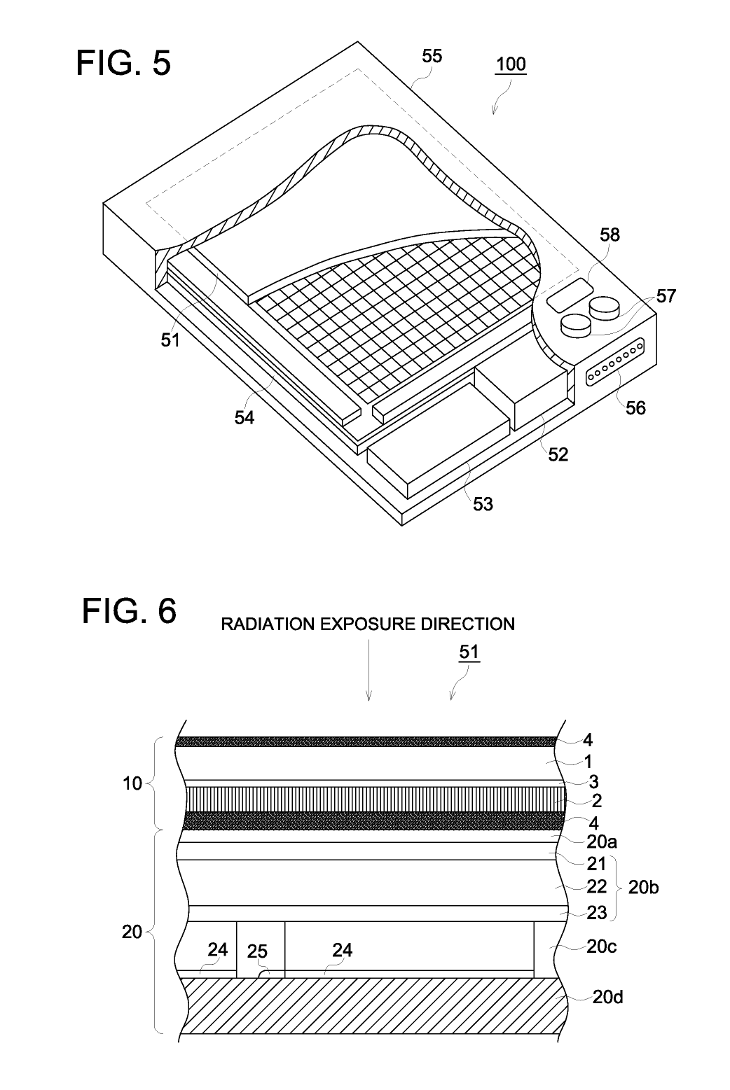

Hereinafter, there will be described constitution of a radiation image detecting apparatus 100 provided with the scintillator plate 10 as an application example of the radiation scintillator panel 10 with reference to FIGS. 5 and 6. FIG. 5 illustrates a partially fractured perspective view showing a constitution of a radiation image detecting apparatus 100. FIG. 6 illustrates an enlarged sectional view of an imaging panel 51.

In the radiation image detecting apparatus 100, as shown in FIG. 5, an imaging panel 51, a control section 52 to control movement of the radiation image detecting apparatus 100, a memory section 53 to memorize image signals outputted from the imaging panel 51 by using rewritable dedicated memory (e.g., flash memory), and a power source section 54 of a power supplier to supply a power necessary to obtain image signals by driving the imaging panel 51 are provided in the interior of a housing 55. The housing 55 is provided with a connector 56 for communication to communicate from the radiation image detecting apparatus 100 to the exterior if needed, an operation section 57 to change motion of the radiation image detecting apparatus 100, a display section 58 to show completion of preparation for picture-taking or writing-in of an prescribed amount of image signals to a memory section 53, and the like.

Herein, if the radiation image detecting apparatus 100 is provided with the memory section 53 to memorize image signals of a radiation image together with the power source section 54 and is designated to be detachable through the connector 56, the radiation image detecting apparatus 100 can become a portable structure.

As shown in FIG. 6, an image panel 51 is constituted of a radiation scintillator panel 10 and an output substrate 20 to absorb electromagnetic waves from the radiation scintillator panel 10 and output image signals.

The radiation scintillator panel 10 is disposed on the side of the radiation-exposed surface and is constituted so as to emit an electromagnetic wave in accordance with the intensity of incident radiation.

An output substrate 20 is provided on the opposite surface to the radiation-exposed surface of the radiation scintillator panel 10, and a diaphragm 20a, a photoelectric conversion element 20b, an image signal output layer 20c and the substrate 20d are sequentially provided from the side of the radiation scintillator panel 10. The diaphragm 20a is provided to separate the radiation scintillator panel 10 from other layers.

The photoelectric conversion element 20b is constituted of a transparent electrode 21, a charge generation layer 22 which generates a charge upon excitation by electromagnetic waves transmitted through the transparent electrode 21 and a counter electrode 23 opposed to the transparent electrode 21; and the transparent electrode 21, the charge generation layer 22 and the counter electrode 23 are sequentially arranged from the diaphragm 20a side.

The transparent electrode 21 is an electrode capable of transmitting electromagnetic waves to be photoelectrically converted and is formed by using, for example, an electrically conductive transparent material such as indium tin oxide (ITO), SnO₂ or ZnO.

The charge generation layer 22 is formed in a thin layer form on one surface side of the transparent electrode 21 and contains an organic compound capable of performing charge separation on exposure to light, as a photoelectric-convertible compound, and containing an electron donor capable of generating a charge and an electrically conductive compound as an electron acceptor, respectively. In the charge generation layer 22, the electron donor is excited upon incidence of an electromagnetic wave and releases an electron, and the released electron is transferred to the electron acceptor so that a charge, that is, carriers of a hole and an electron are generated in the charge generation layer.

Electrically conductive compounds as an electron donor include a p-type conductive polymer compound. A p-type conductive polymer compound preferably is a compound having a basic backbone of polyphenylene-vinylene, polythiophene, poly(thiophenevinylene), polyacetylene, polypyrrole, polyfluorene, poly(p-phenylene) or polyaniline.

Electrically conductive compounds as an electron acceptor include an n-type conductive polymer compound. An n-type conductive polymer compound preferably is a compound having a basic backbone of polypyridine, and more preferably a backbone of poly(p-pyridylvinylene).

The thickness of the charge generation layer 22 is preferably not less than 10 nm (and more preferably, not less than 100 nm) to secure a light absorption amount, and is preferably not more than 1 μm (and more preferably, not more than 300 nm) from the point of view that electrical resistance is not excessively large.

The counter electrode 23 is disposed on the opposite side of the side of the surface where electromagnetic waves of the charge generation layer 22 enter. The counter electrode 23 may employ by selecting one from conventional metal electrode such as gold, silver, aluminum and chromium, and the transparent electrode 21; however, to achieve superior characteristics, it is preferred to employ, as an electrode material, one of a metal, alloy, and electrically conductive compound which are low in work function (4.5 eV or less), and their mixture.

Between the respective electrodes sandwiching the charge generation layer 22, that is, transparent electrode 21 and counter electrode 23, there may be provided a buffer layer which acts as a buffer zone so that the charge generation layer 22 is not reacted with these electrodes. The buffer layer is formed by use of for example, lithium fluoride, poly(3,4-ethylenedioxythiophene:poly(4-styrenesulfonate), or 2,9-dimethyl-4,7-diphenyl[1,10]phenathroline.

The image signal output layer 20c accumulates a charge obtained in the photoelectric conversion element 20b and outputs signals based on the accumulated charge and is constituted of a condenser 24 as a charge accumulating device to accumulate a charge produced in the photoelectric conversion element 20b for the respective picture elements and a transistor 25 as an image signal output element to output the accumulated charge as a signal.

The transistor 25 uses, for example, TFT (Thin Film Transistor). The TFT may be one employing an inorganic semiconductor which is employed in a liquid crystal display or one employing an organic semiconductor, and preferably a TFT formed on plastic film.

There is known amorphous silicon as a TFT formed on plastic film. Further, TFT may be formed on a flexible plastic film by FSA (Fluidic Self Assembly) technique, that is, by arraying minute CMOS (Nanoblocks) made of a single crystal silicon on an embossed plastic film. It may be a TFT by use of an organic semiconductor, as described in the relevant literature, Science, 283, 822 (1999); Appl. Phys. Lett. 771488 (1998); and Nature, 403, 521 (2000).

The transistor 25 preferably is a TFT prepared by the foregoing FSA technique or a TFT by use of an organic semiconductor and the TFT by use of an organic semiconductor is specifically preferred. When constituting a TFT by use of such an organic semiconductor, installations such as a vacuum deposition device which is used in preparation of TFT by use of silicon are not required and a TFT can be formed by utilizing a printing technique or an ink jet technique, leading to reduction of production cost. Further, a lowering of processing temperature renders it feasible to form a TFT on a heat-sensitive plastic substrate.

The transistor 25 accumulates an electric charge generated in the photoelectric conversion element 20b and is also connected to a collection electrode (not shown in the drawing) as one electrode of the condenser 24. Electric charge produced in the photoelectric conversion element 24 is accumulated in the condenser 24 and the accumulated charge is read by driving the transistor 25. Namely, driving the transistor 25 can allow a signal for each pixel to be outputed.

The substrate 20d functions as a support of the image panel 51 and can be constituted of the same material as the substrate 1.

Next, there will be described action of a radiation image detecting apparatus 100.

First, radiation which has entered the radiation image detecting apparatus 100 enters from the radiation scintillator panel 10 side toward the substrate 20d side. When radiation has entered the scintillator panel 10, a scintillator layer 2 of the scintillator panel 10 absorbs the radiation energy, and emits electromagnetic waves corresponding to its intensity.

Of emitted electromagnetic waves, electromagnetic waves which have entered the output substrate 20 penetrate the diaphragm 20a of the output substrate 20 and the transparent electrode 21 and reach the charge generation layer 22. Then, the electromagnetic waves are absorbed in the charge generation layer 22 and form pairs of positive hole and electron (charge separation state) in response to its intensity.

Then, positive holes and electrons are respectively conveyed to different electrodes (transparent electrode membrane and conductive layer, so that e a photoelectric current flows.

Thereafter, positive holes conveyed to the counter electrode 23 side are accumulated in the condenser 24. The accumulated positive holes output image signals by driving the transistor 25 connected to the condenser 24 and the outputted image signals are stored in the memory section 53.

The radiation image detecting apparatus 100, which is provided with the foregoing the scintillator panel 10, can achieved enhanced photoelectric conversion efficiency, whereby enhanced S/N ratio can be achieved even when photographed at a relatively low dose, and uneven images or streak noises can also prevented.

### EXAMPLES

Hereinafter, the present invention will be further detailed with reference to examples but the invention is by no means limited to these.

### Preparation of Substrate 1:

Aluminum was sputtered onto a 125 μm thick polyimide film of 250×250 mm size (glass transition temperature: 285° C., Upilex, produced by Ube Kosan Co.) to form a reflection layer (0.10 μm).

### Preparation of Substrate 2:

A 500 μm thick mirror-faced aluminum plate was cut to a size of 250×250 mm.

### Preparation of Sublayer:

| | |
|---|---|
| Vylon 20SS (made by TOYOBO Co., Ltd., | 300 parts by mass |
| polyester resin) | |
| Methyl ethyl ketone | 200 parts by mass |
| Toluene | 300 parts by mass |
| Cyclohexanone | 150 parts by mass |

The foregoing composition was mixed and dispersed in a bead-mill for 15 hours to obtain a coating solution used for subbing. The coating solution was coated onto the reflection layer side of the substrate by a spin coater so that a dry thickness was 1.0 μm and then dried at 100° C. for 8 hours to form a sublayer.

### Formation of Phosphor Layer:

Using a vapor deposition device, as shown in FIG. 3, a phosphor (CsI:0.03Tl mol %) was allowed to deposit on the sublayer side of the substrate to form a 500 μm thick phosphor layer. A shutter (not shown in the drawing) was disposed between the boat 963 and the holder 964 to inhibit adherence of substances other than an objective material at the time of initiation of vapor deposition.

Specifically, raw phosphor material as an evaporation material was placed into a resistance heating crucible, a substrate was set onto a rotary substrate (support) holder, and the distance between the substrate and an evaporation source was adjusted to 500 mm.

Subsequently, the interior of the vapor deposition device was evacuated and then, Ar gas was introduced thereto to adjust the vacuum degree to 0.5 Pa; thereafter, the substrate was maintained at 200° C., while rotating the substrate at a rate of 10 rpm. Then, the resistance heating crucible was heated to allow a phosphor to be deposited to form a 500 μm thick phosphor layer.

### Formation of Protective Layer:

With respect to samples required to provide a protective layer, the protective layer was provided in the following manner.

(1) Reduced-pressure sealing method: an obtained phosphor plate was placed into a three-sided seal bag of a film described below and sealed under reduced pressure to obtain a scintillator plate.

Used film: Mitsubishi Jushi Tech Barrier Film HX//casing Polypropylene

(2) Parylene method: Parylene (poly-p-xylylene, produced by Nippon Parylene Co.) was vapor-deposited onto an obtained phosphor plate through a CVD method to obtain a scintillator sample. Parylene thickness was 40 μm.

### Preparation of Radiation Image Detecting Apparatus:

An obtained scintillator and a photoelectric conversion panel were adhered each other to obtain a radiation image detecting apparatus. There were prepared a 30×30 cm photoelectric conversion panel and an opposed base material (AN100, 0.6 mmt glass, produced by Asahi Glass Co., Ltd.). First, a 25×25 cm scintillator was fixed by a matrix tape onto the central portion of the opposed base material. Then, the adhesive shown in the Table was coated onto the portion of 5 mm apart from the edge of the opposed base material to be brought into contact with the photoelectric conversion panel. The thus contacted panel was placed into a decompression desiccator. The interior of the desiccator was evacuated, while being exposed to a metal halide lamp, made by Oak Co. The pressure of the interior was 1000 Pa and was returned to atmospheric pressure after being maintained under 1000 Pa for 1 minute. Then, the adhered panel was placed into a housing to obtain a radiation image detecting apparatus.

### Preparation of Comparative Radiation Image Detecting Apparatus:

A radiation image detecting apparatus, for comparison, was prepared in the same manner as Sample 3, except that adhering a scintillator to a photoelectric conversion panel was conducted, as described below.

Adhering: A scintillator was adhered onto an opposed base material by a matrix tape. A low-viscous UV-curable adhesive, Three Bond 3042B, was coated onto the scintillator surface at a thickness of 1 μm. The opposed base material and a photoelectric conversion panel were brought into contact with each other and while applying pressure of 20 g/cm², a metal halide lamp was irradiated thereto to adhere the panel.

### Obtaining of Radiation Image:

The radiation incident face side of a radiation image detecting apparatus set with the foregoing scintillator was exposed to 3.0 mR X-rays at a tube voltage of 70 kVp and calibration (Gain correction) was conducted so that output from the individual image elements for incident X-rays, including emission intensity unevenness of the scintillator, became identical. Then, exposure to 1.0 mR X-rays at a tube voltage of 70 kVp was conducted and obtained digital signals were recorded on a hard disk to obtain an image.

### MTF Evaluation:

After confirming that a normal image was obtained, a MTF measurement was conducted by an edge method and analysis values at 2 ln/mm were recorded and written into a Table. A larger value is better contact and a value of not less than 0.2 is within a range of being acceptable in practice.

### Moisture Resistance Evaluation:

Samples, which were evaluated with respect to the foregoing MTF, were allowed to stand for 30 days in an incubator at 30° C. and 90% RH. After incubation, MTF measurement was conducted in the same manner as above and recorded as a relative value, based on the initial value being 1. A larger value is less in performance variation from the initial time and a value of not less than 0.85 is within the range of being acceptable in practice.

The foregoing evaluation results are shown in Table 1.

TABLE 1

| | | | Moisture | | | | | |
|---|---|---|---|---|---|---|---|---|
| | | | Permeability | | | | | |
| Sample | Related | | of Adhesive | | Protective | Base | | Moisture |
| No. | Claims | Adhesive | Portion* | | Layer | Board | MTF | Resistance |
| 1 | 1, 2, 3, 4, 5 | ThreeBond 3025G | 5 | g/m²-day | — | PI | 0.365 | 0.92 |
| 2 | 1, 2, 3, 4 | ThreeBond 3025G | 5 | g/m²-day | (1) sealing | PI | 0.320 | 0.88 |
| 3 | 1, 2, 3, 4 | ThreeBond 3025G | 5 | g/m²-day | (2) Parylene | PI | 0.325 | 0.88 |
| 4 | 1, 2, 3 | ThreeBond 3025G | 5 | g/m²-day | (1) sealing | Aluminum | 0.295 | 0.88 |
| 5 | 1, 2, 4 | ThreeBond 3026E | 35 | g/m²-day | (1) sealing | PI | 0.310 | 0.86 |
| 6 | Comp. | | | | (2) Parylene | Aluminum | 0.250 | 0.66 |

*Based on JIS-Z-0208

As is apparent from the results shown in Table 1, it is proved that Examples related to the present invention were superior in sharpness (MTF) and moisture resistance.

1. A radiation image detecting apparatus provided with a photoelectric conversion panel and a scintillator panel comprising a phosphor layer on a substrate,
wherein:
the scintillator panel is held between the photoelectric conversion panel and an opposed base material,
a periphery of the photoelectric conversion panel adheres to a periphery of the opposed base material with an adhesive, and
a pressure of a gas in a space between the photoelectric conversion panel and the opposed base material is lower than an atmospheric pressure.

2. The radiation image detecting apparatus as claimed in claim 1, wherein the scintillator panel adheres to the opposed base material, and the scintillator panel is in contact with the photoelectric conversion panel under a reduced pressure.

3. The radiation image detecting apparatus as claimed in claim 1, wherein a moisture permeability at adhered portions on the peripheries is not more than 30 g/m²/μm under a temperature of 40° C. and a relative humidity of 90%.

4. The radiation image detecting apparatus as claimed in claim 1, wherein the substrate of the scintillator panel is flexible.

5. The radiation image detecting apparatus as claimed in claim 1, wherein the phosphor layer is in direct contact with the photoelectric conversion panel.

6. The radiation image detecting apparatus as claimed in claim 1, wherein the phosphor layer is formed by a process of vapor deposition.

7. The radiation image detecting apparatus as claimed in claim 1, wherein the phosphor layer is formed from raw materials including cesium iodide and an additive containing thallium.
